(19) United States
(12) Patent Application Publication
(10) Pub. No.: US 2007/0059071 A1
(43) Pub. Date: Mar. 15, 2007

(54) Image forming apparatus reducing an occurrence of disturbing an image

(76) Inventors: Akira Shinshi, Tokyo (JP); Masahiko Satoh, Tokyo (JP); Takahiro Nakayama, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/521,472

(22) Filed: Sep. 15, 2006

(30) Foreign Application Priority Data
Sep. 15, 2005 (JP) 2005-267811

(51) Int. Cl. G03G 15/00

(52) U.S. Cl. 399/400

(57) ABSTRACT

An image forming apparatus forming an image on a transfer sheet includes a transfer unit including a transfer nip, a fixing unit including a fixing nip and driven by a drive source, and a registration unit driven by the drive source. A formula (Vtc+Vth)=(2Lp−Lmin−Lmax)/Tr is satisfied or expressions Vtc>(Lp−Lmax)/Tr and Vth<(Lp−Lmin)/Tr are satisfied in which the sheet has a length Lp, the fixing unit has a sheet conveyance speed Vtc immediately after started, the sheet has a sheet conveyance speed Vth after a predetermined number of the sheets are continuously fed, the transfer and fixing units have a shortest conveyance distance Lmin when the sheet is conveyed, the transfer and fixing units have a longest conveyance distance Lmax, and the sheet has a time Tr necessary for a tailing end thereof to reach the transfer nip with a predetermined speed when a leading end and a middle portion thereof are respectively in the fixing and transfer nips.

### CROSS-REFERENCE TO RELATED APPLICATION

This patent specification is based on Japanese patent application No. 2005-267811 filed on Sep. 15, 2005 in the Japanese Patent Office, the entire contents of which are hereby incorporated by reference herein.

### BACKGROUND OF THE INVENTION

1. Field of the Invention

An exemplary aspect of the present invention relates to an apparatus for image forming, and more particularly to an apparatus for image forming capable of effectively reducing an occurrence of disturbing an image.

2. Description of the Background Art

A background art image forming apparatus employing an electrophotographic method is configured to, for example, form an electrostatic latent image on an image carrying member, referred to as a photoconductor drum, develop the latent image on the photoconductor drum by a developer including toner to form a toner image, transfer the developed toner image onto a transfer sheet by a transfer unit so that the image is carried, fix the toner image onto the transfer sheet by a fixing unit using, for example, pressure and heat, and eject the transfer sheet with the fixed image to an outside thereof through an ejection path.

The fixing unit includes a fixing rotation member that includes rollers or belts opposing each other or a combination of rollers or belts. The transfer sheet is nipped in the fixing unit in which pressure and heat are applied. Thereby, the toner image transferred by the transfer unit is fixed on the transfer sheet. The fixing rotation member includes a heat roller, a fixing belt, and a pressure roller, for example. The heat roller includes a heater, referred to as a heating mechanism, the fixing belt, referred to as a fixing member, includes a fixing roller with a rubber surface layer therein, and the pressure roller, referred to as a pressure member, is abutted on the fixing belt. When the transfer sheet with the transferred toner image reaches the fixing unit, the sheet is transferred to a fixing nip formed between the fixing belt and pressure roller so that the toner image is fixed by the pressure and heat in a course of passing through the fixing nip.

In general, the background art image forming apparatus includes a conveyance path. The conveyance path includes a registration roller, a transfer belt (or a transfer roller), a fixing roller, an ejection roller, and a guiding member. The registration roller conveys the transfer sheet fed from a sheet feeder at a desired timing to an image forming device. The transfer belt transfers and conveys the transfer sheet. The fixing roller fixes the toner, and the ejection roller ejects the sheet. The guiding member guides the sheet among these rollers.

The background art image forming apparatus may generate a shock jitter or a smudged image due to a conveyance nature. A shock jitter that disturbs the image is generated by a vibration in a transfer unit caused by releasing a load when a trailing end of the sheet passes the transfer unit. This occurs when the sheet is pulled between the fixing and transfer units because a sheet conveyance speed of the fixing unit is faster than that of the transfer unit. On the other hand, when the sheet has slack between the fixing and transfer units, the trailing end of the sheet is in contact with the transfer roller (or the transfer belt) so that a smudged image may be generated.

An example of attempting to deal with the shock jitter and smudged image is to adjust a drive speed of the transfer and fixing units. However, when the drive speed of the fixing unit becomes excessive, the shock jitter is generated. When the drive speed of the fixing unit becomes slower than a reasonable level, the smudged image is generated. The shock jitter and smudged image are also generated when a linear velocity is fluctuated by thermal expansion of the fixing roller or pressure roller caused by an increase in fixing temperature while the paper is passing.

A theory of fluctuating the conveyance speed for the fixing unit has been known. According to this known theory, the conveyance speed is detected when the paper is passing, or an appropriate conveyance speed is determined beforehand based on an experiment. However, in the image forming apparatus having a drive source used for both the fixing unit and a registration unit, a registration speed is fluctuated with respect to the fixing unit when the drive speed of the fixing unit fluctuates.

Another example has attempted to adjust the speed of a motor that is mainly used for the fixing unit to deal with the shock jitter and smudged image.

Still another example has attempted to enhance a guiding nature of the paper to deal with the shock jitter and smudged image.

### SUMMARY OF THE INVENTION

An image forming apparatus forming a toner image on a transfer sheet includes a transfer unit having a transfer nip, a fixing unit having a fixing nip and driven by a drive source, and a registration unit driven by the drive source driving the fixing unit. A formula (Vtc+Vth)=(2Lp−Lmin−Lmax)/Tr is satisfied, in which the transfer sheet has a length Lp, the fixing unit has a sheet conveyance speed Vtc immediately after the fixing unit is started, the transfer sheet has a sheet conveyance speed Vth after a predetermined number of the transfer sheets are continuously fed, the transfer unit and the fixing unit have a shortest conveyance distance Lmin therebetween when the transfer sheet is conveyed, the transfer unit and the fixing unit have a longest conveyance distance Lmax, and the transfer sheet has a time Tr which is necessary for a tailing end thereof to reach the transfer nip with a predetermined printing speed in a state that a leading end thereof is located in the fixing nip and a middle portion thereof is located in the transfer nip.

An image forming apparatus forming a toner image on a transfer sheet with an electrophotographic method includes a transfer unit, a fixing unit, and a guiding member located between the transfer and fixing units retractable by a predetermined load. Expressions Vtc>(Lp−Lmax)/Tr, and Vth<(Lp−Lmin)/Tr are satisfied, in which the transfer sheet has a length Lp, the fixing unit has a sheet conveyance speed Vtc immediately after the fixing unit is started, the transfer sheet has a sheet conveyance speed Vth after a predetermined number of the transfer sheets are continuously fed, the transfer unit and the fixing unit have a shortest conveyance distance Lmin therebetween when the transfer sheet is conveyed, the transfer unit and the fixing unit have a longest conveyance distance Lmax, and the transfer sheet has a time Tr which is necessary for a tailing end thereof to reach the transfer nip with a predetermined printing speed in a state that a leading end thereof is located in a fixing nip and a middle portion thereof is located in the transfer nip.

### BRIEF DESCRIPTION OF THE DRAWINGS

A more complete appreciation of the exemplary aspects of the invention and many of the attendant advantage thereof will be readily obtained as the same becomes better understood by reference to the following detailed description when considered in connection with the accompanying drawings, wherein:

FIG. 1 is a schematic diagram illustrating an image forming apparatus according to an exemplary embodiment of the present invention;

FIG. 2 is an enlarged diagram illustrating an image forming unit included in the image forming apparatus of FIG. 1;

FIG. 3 is a diagram illustrating a fixing unit included in the image forming apparatus of FIG. 1;

FIG. 4 is a diagram illustrating a transfer sheet on a sheet conveyance path included in the image forming apparatus of FIG. 1;

FIG. 5 is a diagram illustrating a length of a transfer sheet; and

FIGS. 6A and 6B illustrate a sheet conveyance path according to another exemplary embodiment of the present invention.

### DETAILED DESCRIPTION OF EXEMPLARY EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, an image forming apparatus according to at least a first exemplary embodiment of the present invention is described.

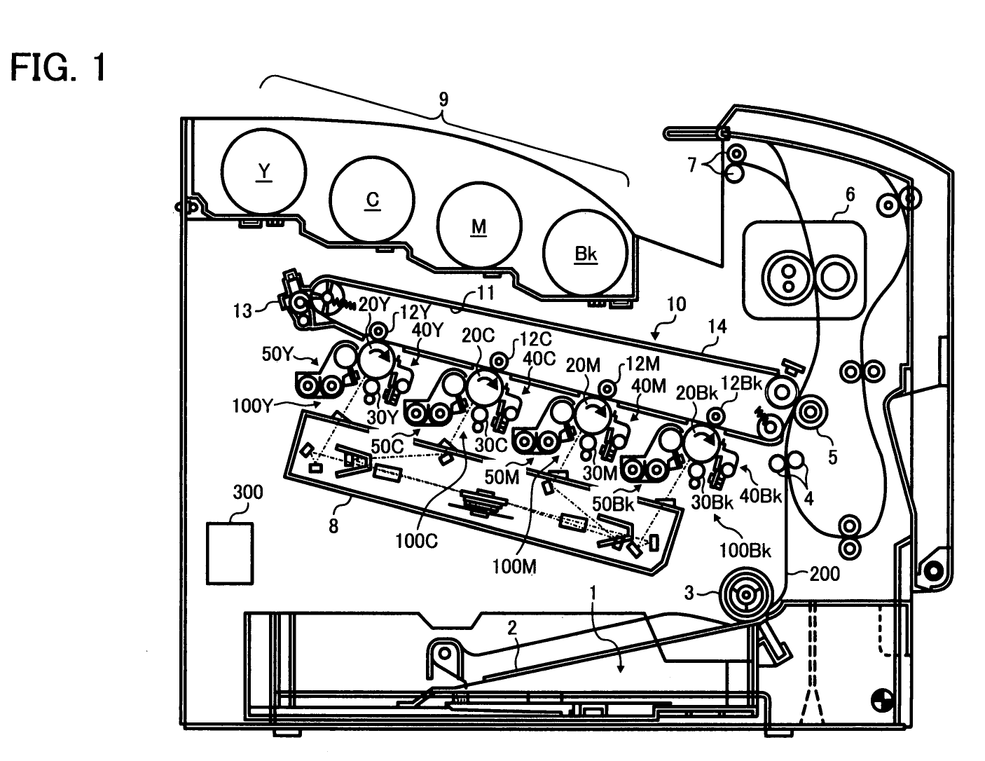

Referring to FIG. 1, the image forming apparatus capable of forming a color image includes a transfer belt unit 10, four image forming units 100Y, 100C, 100M, and 100Bk, four toner bottles 9Y, 9C, 9M, and 9Bk, a transfer sheet 2, a sheet cassette 1, a feed roller 3, a pair of registration rollers 4 (may be referred to as a registration unit), secondary transfer rollers 5, a fixing unit 6, ejection rollers 7, a belt cleaner 13, an optical writing device 8, a controller 300, and a sheet conveyance path 200.

The transfer belt unit 10 includes an intermediate transfer belt 11, primary transfer rollers 12Y, 12C, 12M, and 12Bk, and a belt case 14. The four image forming units 100Y, 100C, 100M, and 100Bk respectively include photoconductor drums (also referred to as image carrying members) 20Y, 20C, 20M, and 20Bk, charging devices 30Y, 30C, 30M, and 30Bk, development devices 50Y, 50C, 50M, and 50Bk, and cleaning devices 40Y, 40C, 40M, and 40Bk. The reference symbols Y, C, M, and Bk indicate yellow, cyan, magenta, and black of toner colors respectively. However, the reference color symbols may be used or omitted as may be needed.

The intermediate transfer belt 11 included in the transfer belt unit 10 is a transfer medium. The primary rollers 12 are used for a primary transfer. The belt case 14 includes the intermediate transfer belt 11. In each of the four image forming units 100, the photoconductor drum 20 forms an electrostatic latent image thereon. The charging device 30 uniformly charges the respective photoconductor drum 20. The development device 50 develops respective electrostatic latent image on the photoconductor drum 20 to form a toner image. The cleaning device 40 removes remaining residual toner from the photoconductor drum 20. The four toner bottles 9Y, 9C, 9M, and 9Bk respectively store toner of yellow, cyan, magenta, and black.

The transfer sheet 2 may be a sheet of paper. The sheet cassette 1 stores the transfer sheet 2. The feed roller 3 feeds the transfer sheet 2 from the sheet cassette 1. The pair of registration rollers 4 registers the transfer sheet 2 so as to convey the sheet at a proper timing. The secondary transfer rollers 5 are used for the secondary transfer. The fixing unit 6 fixes the toner image on the transfer sheet 2. The ejection rollers 7 eject the sheet 2. The belt cleaner 13 removes remaining residual toner from the intermediate transfer belt 11. The optical writing device 8 outputs laser light so as to expose the photoconductors 20 on which the electrostatic latent images are formed.

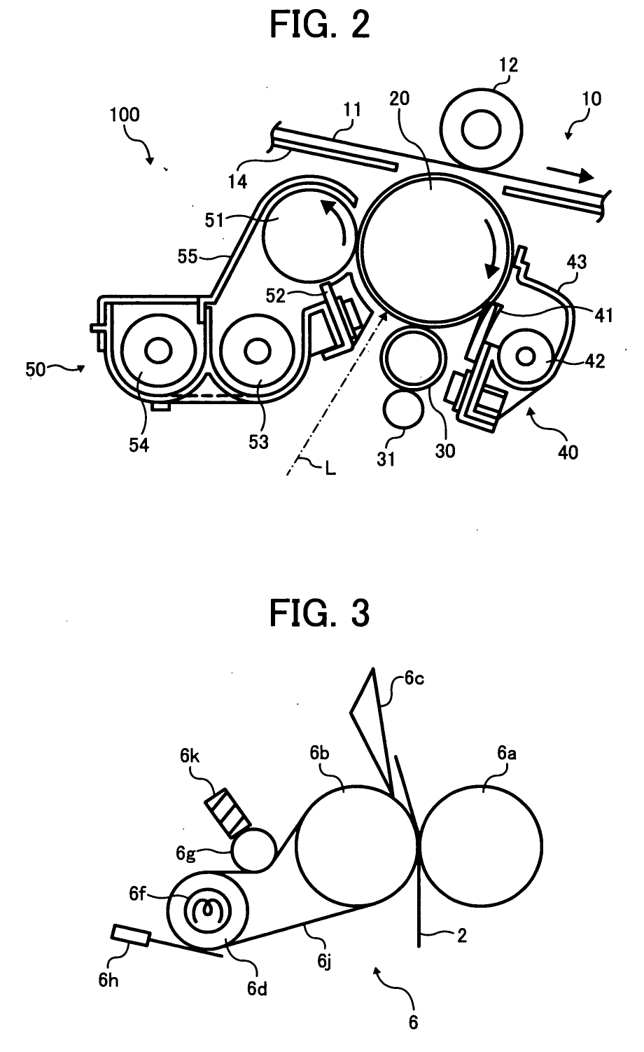

The controller 300 includes a CPU (central processing unit), a ROM (read only memory), and a RAM (random access memory), which are not shown, and controls the entire operations of the image forming apparatus. Specifically, the controller 300 of this embodiment controls a rotation speed of the registration rollers 4 to maintain consistency of speed in the sheet conveyance system. The sheet conveyance path 200 is a path on which the sheet 2 is conveyed. A detailed description of the image forming unit 100 will be given with reference to FIG. 2.

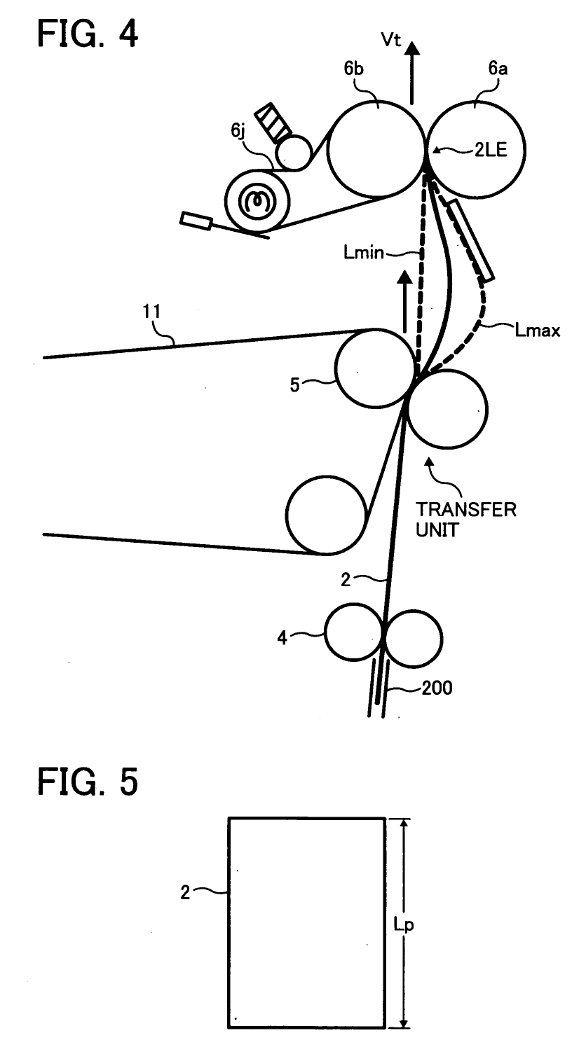

In an image forming operation, the transfer sheet 2 is fed from the sheet cassette 1 by the feed roller 3 and is conveyed to the pair of registration rollers 4. When a leading end of the transfer sheet 2 reaches the pair of registration rollers 4, the sheet 2 is detected by a detection sensor (not shown) so as to be conveyed by the registration rollers 4 to a first nip (included in a transfer unit shown in FIG. 4) formed between the secondary transfer rollers 5 and the intermediate transfer belt 11 at an appropriate timing based on a signal detected by the detection sensor.

The photoconductor drums 20Y, 20C, 20M, and 20Bk are uniformly charged beforehand by the respective charging devices 30Y, 30C, 30M, and 30Bk, and are scanned by the optical writing device 8 with the laser light. Thereby, the electrostatic latent images are formed on the photoconductor drums 20Y, 20C, 20M, 20Bk. These electrostatic latent images on the photoconductor drums 20Y, 20C, 20M, and 20Bk are respectively developed by the development devices 50Y, 50C, 50M, and 50Bk so that the toner images of yellow, cyan, magenta, and black are respectively formed on the photoconductor drums 20Y, 20C, 20M, and 20Bk.

The primary transfer rollers 12Y, 12C, 12M, and 12Bk are applied with voltages, and the toner images on the photoconductor drums 20Y, 20C, 20M, and 20Bk are sequentially transferred onto the intermediate transfer belt 11. The image forming operation for each color is performed by shifting a timing from an upstream side to a downstream side such that each toner image is transferred and superimposed at a same location on the transfer belt 11.

The images (composite color image) formed on the intermediate transfer belt 11 are conveyed to the secondary transfer rollers 5 so as to be secondarily transferred onto the transfer sheet 2. After the transfer sheet 2 with the toner images is conveyed to the fixing unit 6 in which the toner images are fixed by heat and pressure, the transfer sheet 2 is ejected by the ejection rollers 7.

The remaining residual toner on the photoconductors 20Y, 20C, 20M, and 20Bk is removed by the respective cleaning devices 40Y, 40C, 40M, and 40Bk. After removal of the remaining residual toner, the photoconductors 20Y, 20C, 20M, and 20Bk are discharged and charged simultaneously by the charging devices 30Y, 30C, 30M, and 30Bk, which can be applied and superimposed with a bias of an alternating current component in a direct current method, so as to prepare for a next image forming operation. The intermediate transfer belt 11 prepares for the next image forming operation after the remaining residual toner thereon is removed by the belt cleaner 13.

Referring to FIG. 2, one of the image forming units 100Y, 100C, 100M, and 100Bk included in FIG. 1 is enlarged and shown in detail, as representative of the image forming units 100. As shown in FIG. 2, the image forming unit 100 includes the development device 50, cleaning device 40, charging device 30, and photoconductor 20. The development device 50 includes a development case 55, a development roller 51, a development blade 52, a first conveyance screw 53, and a second conveyance screw 54. The cleaning device 40 includes a cleaning case 43, a cleaning blade 41, and a waste toner screw 42. The charging device 30 includes a cleaning roller 31. In the vicinity of the image forming unit 100, transfer belt unit 10 including the transfer belt 11, primary transfer roller 12, and belt case 14 is disposed.

In the development device 50, the development roller 51 is disposed to be opposed to a surface of the photoconductor drum 20 in close proximity, the development blade 52 controls a height of a developer on the development roller to be at a certain level, the first and second conveyance screws 53 and 54 are disposed in locations opposed to the development roller 51, and the development case 55 having an opening includes the development roller 51, and conveyance screws 53 and 54 therein.

In the cleaning device 40, the cleaning blade 41 removes the remaining residual toner from the photoconductor drum 20, the waste toner screw 42 conveys waste toner removed by the cleaning blade 41 to a waste toner bottle (not shown), and the cleaning case 43 having an opening includes the cleaning blade 41 and waste toner screw 42 therein.

The cleaning roller 31 of the charging device 30 cleans the charging device 30.

Reference symbol L in FIG. 2 indicates the laser light from the optical writing device 8.

Referring to FIG. 3, the fixing unit 6 included in the image forming apparatus of FIG. 1 includes a pressure roller 6a, a fixing roller 6b, a separation plate 6c, a heat roller 6d, a heat source 6f, a tension roller 6g, a thermistor 6h, a fixing belt 6j, and a spring 6k.

The pressure roller 6a is a roller that includes a core, an elastic layer, and a surface layer. The core of the pressure roller 6a is made of, for example, aluminum or iron, and the elastic layer made of, for example, silicon rubber is disposed thereon. The surface layer of the pressure roller 6a is a releasing layer which is made of PFA or PTFE, for example. The fixing belt 6j is configured to have the releasing layer made of, for example, the PFA or PTFE on a base member which is nickel and polyimide, for example, or is configured to have the elastic layer of, for example, the silicon rubber between the base member and the releasing layer. The fixing belt 6j is extends across the fixing roller 6b and the heat roller 6d, and tension thereof is appropriately maintained by the tension roller 6g.

The fixing roller 6b has, for example, a metal core on which the silicon rubber is disposed. The heat roller 6d can be a hollow roller made of, for example, aluminum or iron, and has the heat source 6f, for example a halogen heater, therein. The heat source 6f may employ an IH (induction heater) or other heater instead of the halogen heater.

The transfer sheet 2 is conveyed from a lower portion of FIG. 3 towards a second nip (may be included in the fixing unit 6) formed between the fixing roller 6b and pressure roller 6a. The transfer sheet 2 with the image thereon is fixed in the second nip by predetermined heat and pressure, and is guided by the separation plate 6c so as to be conveyed to an upper portion. A separation tab may be employed instead of the separation plate 6c. The spring 6k adjusts the tension of the fixing belt 6j through the tension roller 6g. The thermistor 6h is a temperature sensor to detect temperature of the heat roller 6d.

In addition to the fixing unit 6 of FIG. 3, a fixing device including a fixing member and a pressure member, each of which is configured by a combination of, for example, a roller and/or a belt, may be applied to the image forming apparatus of the present invention.

Referring to FIG. 4, the transfer sheet 2 on the sheet conveyance path 200 is illustrated. The transfer sheet 2 is fed from the sheet cassette 1 of FIG. 1, and is conveyed at an appropriate timing with a pre-transfer image by the pair of registration rollers 4. After the image is transferred onto the transfer sheet 2 in the first nip formed between the intermediate transfer belt 11 and secondary transfer rollers 5, the transfer sheet is conveyed to the second nip formed between the fixing roller 6b and pressure roller 6a where the heat and pressure are applied thereon to fix the image. The first nip may be included in the transfer unit shown in FIG. 4. FIG. 4 illustrates a situation in which a leading end of the transfer sheet 2 is located in the second nip, and a distortion of the transfer sheet 2 is formed. This distortion is caused by balance between the conveyance path 200 and an elasticity of the transfer sheet 2. The leading end of the transfer sheet 2 is indicated in 2LE in FIG. 4.

The transfer sheet 2 is generally conveyed through the conveyance path 200. However, when a fixing speed is faster with respect to a feeding speed of the transfer sheet 2, the distortion of the transfer sheet 2 is gradually accommodated so as to be at least substantially the same as a shortest conveyance distance Lmin indicated in a dotted line in FIG. 4. Under such a situation, when a tailing end of the transfer sheet 2 passes through the second transfer rollers 5, a load pulling the secondary transfer rollers 5 upward through the transfer sheet 2 is released, and a vibration is generated. This vibration caused by releasing the load reaches the photoconductor drum 20 through the transfer belt 11 so that a shock jitter which may disturb the image is generated.

On the other hand, when the fixing speed is slower with respect to the feeding speed of the secondary transfer rollers 5, the distortion of the transfer sheet 2 is gradually increased so as to be at least substantially the same as a longest conveyance distance, which is indicated as Lmax in FIG. 4. Under such a situation, when the tailing end of the transfer sheet 2 passes through the second transfer rollers 5, the load distorting the transfer sheet 2 is released. Thereby, the tailing end bounces towards the transfer belt 11, and an unfixed image touches the transfer belt 11 so that a smudged image may be generated.

A background art image forming apparatus has attempted to reduce the shock jitter and smudged image by determining a reference speed beforehand. Sheet feeding has been performed according to the reference speed. However, when the sheet feeding for a fixing operation is performed for a long period of time, for example for continuous printing, a diameter of a sheet conveyance roller conveying a sheet of transfer paper is expanded, and the conveyance speed in a fixing unit is accelerated. Thereby, the shock jitter may still be generated. In such a case, a rotation speed of the conveyance roller for the fixing operation may be controlled to deaccelerate during the sheet feeding so that an occurrence of the shock jitter may be reduced. However, when the fixing unit and a registration unit, for example registration rollers, have at least substantially the same drive source, a speed relationship between the registration and fixing units may be deteriorated so that the image is disturbed.

Therefore, this exemplary embodiment employs a configuration that satisfies a formula that will be described later so as to reduce an occurrence of generating image problems including the shock jitter and the smudged image.

Referring to FIG. 5, a length of the transfer sheet 2 is illustrated. This length is used in the formula.

The configuration employed by this exemplary embodiment satisfies a relationship expressed by the formula (1) below.
(Vtc+Vth)=(2Lp−Lmin−Lmax)/Tr, (1)
in which a definition of each abbreviation is stated below.

Lp: A length of the transfer sheet (see FIG. 5).

Vtc: Sheet conveyance speed immediately after the fixing unit is started.

Vth: Sheet conveyance speed after a predetermined number of the transfer sheets are continuously fed.

Lmin: The shortest conveyance distance when the transfer sheet is conveyed between the transfer unit and fixing unit.

Lmax: The longest conveyance distance.

Tr: A time necessary for the tailing end of transfer sheet to reach a transfer nip (for example, the first nip) with a predetermined printing speed in a state that the leading end of transfer sheet is located in a fixing nip (for example, the second nip) and a middle portion of the transfer sheet is located in the transfer nip.

The above formula can be modified by:
(Vtc+Vth)/2={(Lp−Lmin)/Tr+(Lp−Lmax/Tr)}/2 (2).

In other words, this modified formula may be expressed by:

(an average of an upper bound value and a lower bound value of speed at which fixing printing is performed)=(an average of speed at which the transfer sheet becomes the shortest conveyance distance before the tailing end of the transfer sheet reaches the transfer nip and a speed at which the transfer sheet becomes the longest conveyance distance before the tailing end of the transfer sheet reaches the transfer nip).

When a condition of this modified formula (2) is satisfied, an occurrence of generating the image problem may be reduced.

In addition, when the condition of the modified formula (2) is satisfied, an occurrence of pulling or pushing the transfer sheet 2 with respect to the transfer belt 11 of 4 meters may be reduced. Thereby, the load between the transfer sheet 2 and fixing unit 6 is small, and an occurrence of generating paper dust may be reduced. Therefore, occurrences of a problem caused by paper dust, a jam caused by paper dust adhering to a guide side of the transfer belt, and a black dot on the image caused by accumulation of a mixture of paper dust and toner may be reduced. The black dot is generated when the image is retransferred.

A detailed description of at least a second exemplary embodiment of the image forming apparatus of the present invention will be given as follows.

When the sheet feeding of two sides of the transfer sheet 2 is performed, the transfer sheet 2 with a printed first side is once moved towards an ejection direction, and is switched back. The transfer sheet 2 is reinserted to the registration unit through a two-side conveyance path. At this time, since the transfer sheet 2 has been heated in the fixing unit 6, a diameter of each registration roller 4 is varied by thermal expansion when continuous sheet feeding of the two sides of the transfer sheets 2 is performed. Thereby, a sheet conveyance speed of the registration unit is gradually accelerated. Therefore, the transfer sheet 2 pressed by the registration unit may be skidded at the transfer unit, and the image may be disturbed.

As for the continuous sheet feeding of the two sides of the transfer sheets 2 in this exemplary embodiment, a number of the transfer sheets, or the diameter of the registration roller and the conveyance speed, vary according to a length of time, which are determined beforehand based on experiments. A rotation speed of the registration roller 4 is switched to a speed that is at least substantially the same as the conveyance speed of a pre-expansion. In other words, the rotation speed of the registration rollers 4 is deaccelerated gradually or in a course of a plurality of phases such that the sheet conveyance speed in the registration unit which is accelerated by the thermal expansion is corrected by the controller 300. This controller 300 provides a constant level of the sheet conveyance speed of the registration unit which is substantially no different than an intermediate transfer speed so that a stable image is obtained.

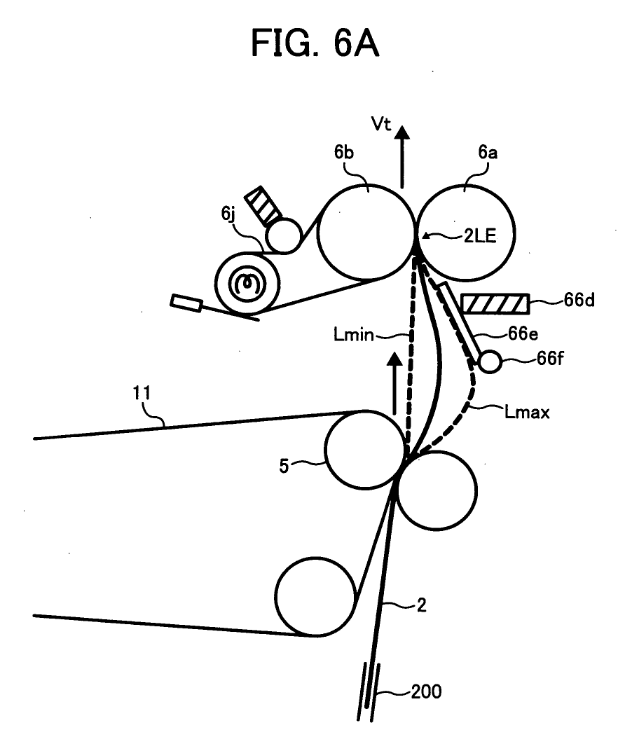

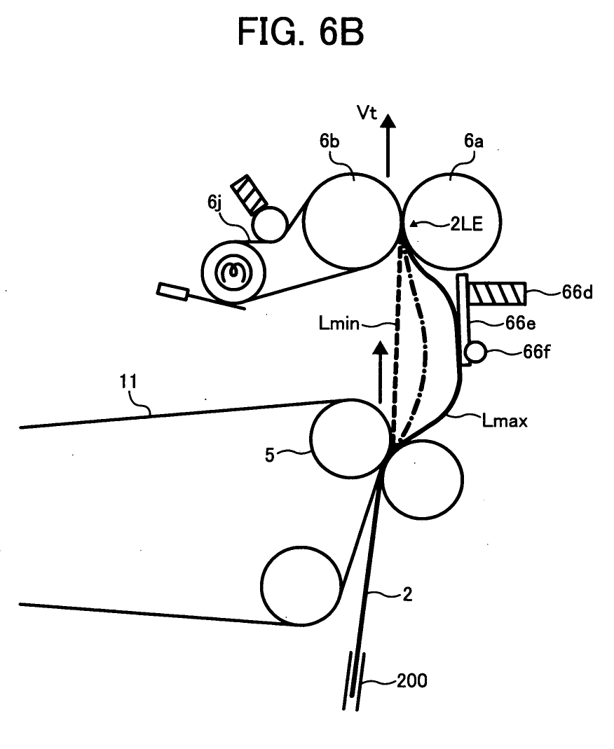

A detailed description of at least a third exemplary embodiment will be given as follows with FIGS. 6A and 6B.

Referring to FIGS. 6A and 6B, the fixing unit 6 and transfer unit with the sheet conveyance path 200 are illustrated. As illustrated in each of FIGS. 6A and 6B, the fixing and transfer units are similar to those of FIG. 4, except for a guiding member 66e, a hinge 66f, and a spring 66d.

The guiding member 66e is a retractable member, and is supported rotatably by the hinge 66f. A force member, for example the spring 66d, applies a force with a predetermined load to a resin guide rib or a metal sheet guide surface of the guide member 66e. The guiding member 66e may be configured to be Mylar adhered in a bending shape and to have appropriate elasticity at a bending portion. By using such a conveyance path 200, which may be shortened or elongated to the level of the Lmin or Lmax as shown in FIG. 6A, when the transfer sheet 2 is distorted to a level of the Lmax, the guide surface of the guiding member 66e is retracted as shown in FIG. 6B so that the sheet conveyance path 200 is secured to be widened because the conveyance path is elongated to the Lmax. A guiding operation, for example by the guiding member 66e, may reduce an occurrence of generating the shock jitter or smudged image regardless of a fixing state by having a configuration that satisfies below expressions (3), (4).
Vtc>(Lp−Lmax)/Tr, and (3)
Vth<(Lp−Lmin/Tr) (4).

The transfer unit may be configured to be a transfer belt method. The pressure roller 6a in the fixing unit 6 may be configured to be a sheet conveyance roller (in a drive side). Obviously, a combination of these configurations may be prepared.

An image forming apparatus capable of forming the color image is described throughout this specification. However, these exemplary embodiments of the present invention may be applied to an image forming apparatus capable of forming a monochrome image.

Numerous additional modifications and variations are possible in light of the above teachings. It is therefore to be understood that within the scope of the appended claims, the disclosure of this patent specification may be practiced otherwise than as specifically described herein.

1. An image forming apparatus forming a toner image on a transfer sheet, comprising:
a transfer unit including a transfer nip;
a fixing unit including a fixing nip and driven by a drive source; and
a registration unit driven by the drive source driving the fixing unit,
wherein:
the transfer sheet has a length Lp;
the fixing unit has a sheet conveyance speed Vtc immediately after the fixing unit is started;
the transfer sheet has a sheet conveyance speed Vth after a predetermined number of the transfer sheets are continuously fed;
the transfer unit and the fixing unit have a shortest conveyance distance Lmin therebetween when the transfer sheet is conveyed;
the transfer unit and the fixing unit have a longest conveyance distance Lmax; and
the transfer sheet has a time Tr which is necessary for a tailing end thereof to reach the transfer nip with a predetermined printing speed in a state that a leading end thereof is located in the fixing nip and a middle portion thereof is located in the transfer nip, and wherein a formula (Vtc+Vth)=(2Lp−Lmin−Lmax)/Tr is satisfied.

2. The image forming apparatus of claim 1, further comprising a control mechanism configured to switch a number of rotations of the registration unit according to one of conditions of a number of sheets or a time necessary to print on two sides of the transfer sheet.

3. The image forming apparatus of claim 1, wherein the transfer unit includes a transfer belt system.

4. The image forming apparatus of claim 1, wherein the fixing unit includes a roller that functions as a pressure roller and a sheet conveyance drive roller.

5. The image forming apparatus of claim 1, wherein the transfer unit includes a transfer belt system, and the fixing unit includes a roller that fimctions as a pressure roller and a sheet conveyance drive roller.

6. An image forming apparatus forming a toner image on a transfer sheet with an electrophotographic method, the apparatus comprising:
a transfer unit including a transfer nip;
a fixing unit including a fixing nip; and
a guiding member located between the transfer and fixing units retractable by a predetermined load,
wherein:
the transfer sheet has a length Lp;
the fixing unit has a sheet conveyance speed Vtc immediately after the fixing unit is started;
the transfer sheet has a sheet conveyance speed Vth after a predetermined number of the transfer sheets are continuously fed;
the transfer unit and the fixing unit have a shortest conveyance distance Lmin therebetween when the transfer sheet is conveyed;
the transfer unit and the fixing unit have a longest conveyance distance Lmax; and
the transfer sheet has a time Tr which is necessary for a tailing end thereof to reach the transfer nip with predetermined printing speed in a state that a leading end thereof is located in a fixing nip and a middle portion thereof is located in the transfer nip, and
wherein expressions, Vtc>(Lp−Lmax)/Tr, and Vth<(Lp−Lmin)/Tr are satisfied.

7. The image forming apparatus of claim 6, wherein the transfer unit includes a transfer belt system.

8. The image forming apparatus of claim 6, wherein the fixing unit includes a roller that functions as a pressure roller and a sheet conveyance drive roller.

9. The image forming apparatus of claim 6, wherein the transfer unit includes a transfer belt system, and the fixing unit includes a roller that functions as a pressure roller and a sheet conveyance drive roller.

10. An image forming apparatus forming a toner image on a transfer sheet, comprising:
means for transferring a toner image onto the transfer sheet at a transfer nip;
means for fixing the toner image onto the transfer sheet at a fixing nip; and
means for registration of supplying the transfer sheet to the means for transferring,
wherein:
the transfer sheet has a length Lp;
the means for fixing has a sheet conveyance speed Vtc immediately after the means for fixing is started;
the transfer sheet has a sheet conveyance speed Vth after a predetermined number of the transfer sheets are continuously fed;
the means for transferring and the means for fixing have a shortest conveyance distance Lmin therebetween when the transfer sheet is conveyed;
the means for transferring and the means for fixing have a longest conveyance distance Lmax; and
the transfer sheet has a time Tr which is necessary for a tailing end thereof to reach the transfer nip with a predetermined printing speed in a state that a leading end thereof is located in the fixing nip and a middle portion thereof is located in the transfer nip, and wherein a formula (Vtc+Vth)=(2Lp−Lmin−Lmax)/Tr is satisfied.

11. The image forming apparatus of claim 10, further comprising means for switching a number of rotations of the means for registration according to one of conditions of a number of sheets or a time necessary to print on two sides of the transfer sheet.
